(19) United States
(12) Patent Application Publication
(10) Pub. No.: US 2010/0025248 A1
(43) Pub. Date: Feb. 4, 2010

(54) ELECTROPHOERSIS CHIP

(75) Inventor: Wataru HATTORI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 12/534,671

(22) Filed: Aug. 3, 2009

(30) Foreign Application Priority Data
Aug. 4, 2008 (JP) P2008-201026

(51) Int. Cl. G01N 27/26

(52) U.S. Cl. 204/601

(57) ABSTRACT

An electrophoresis chip capable of suppressing the drift phenomenon is provided. The electrophoresis chip includes a channel which separates a sample by isoelectric focusing electrophoresis and a plurality of columnar structures disposed all over the channel. The columnar structures are disposed such that the flow of a sample solution, which moves in the longitudinal direction of the channel, is disturbed.

### BACKGROUND OF THE INVENTION

1. Field of the Invention

The present invention relates to an electrophoresis chip with a channel which separates a desired sample, which contains a plurality of components, into the respective components by isoelectric focusing electrophoresis.

Priority is claimed on Japanese Patent Application No. 2008-201026, filed Aug. 4, 2008, the content of which is incorporated herein by reference.

2. Description of Related Art

In recent years, devices called electrophoresis chips are under development. The electrophoresis chip has a channel therein and separates a sample, such as DNA or protein, within the channel by electrophoresis.

Moreover, there is also an electrophoresis chip which separates a sample, such as DNA or protein, according to the size of the sample by using a groove between the columnar structures formed in the channel. In such an electrophoresis chip, the width of the groove between the columnar structures is almost equal to the size of the sample, such as DNA or protein.

Moreover, there is also an electrophoresis chip which separates a sample, such as protein, by isoelectric focusing electrophoresis. In such an electrophoresis chip, the sample is separated by using the isoelectric points without separating the sample according to the size. For this reason, the width of the groove between the columnar structures does not need to be equal to the size of the sample. The columnar structure of such an electrophoresis chip is formed for the following purpose. For example, the columnar structure is formed to help dissipation of the Joule heat generated during the electrophoresis, to give super-lyophilicity for helping introduction of the sample solution into a channel, to make the sample remain in the channel when the lid is peeled off, or to suppress diffusion of the sample.

In the electrophoresis chip which separates the sample by the isoelectric focusing electrophoresis, however, the drift phenomenon is observed while the isoelectric focusing electrophoresis in which the sample is focused at the isoelectric point is being performed. The drift phenomenon variously changes with the situation of electric charges on the surface of the chip or the contents of the sample. This is the reason why the same observation result cannot be reproduced each time.

For this reason, it is necessary to develop an electrophoresis chip capable of suppressing the drift phenomenon.

Moreover, as a related document there is a document which discloses the technique of accurately performing analysis or separation using a small amount of sample (for example, refer to international publication No. 2005/121767).

In the technique disclosed in international publication No. 2005/121767, the channel of the structure where the edge of a plurality of electrodes to which the AC voltage is applied surrounds the periphery of the main channel, through which a sample existing in a dispersed or floating state in carrier liquid flows together with the carrier liquid, is used. This makes it possible to accurately perform the analysis or separation using a small amount of sample.

Furthermore, there is a document which discloses the technique of operating the flow of fume particles in liquid within a microchannel (for example, refer to JP-A-2004-354364).

In the technique disclosed in JP-A-2004-354364, a channel formed on the substrate is branched into channels at the branch point In addition, blocking materials each of which has a columnar structure are provided and disposed at fixed distances at the branch points of the channels.

Moreover, in FIG. 18 of international publication No. 2005/21767, the structural arrangement in which a number of nano-sized columns are arrayed at fixed pitches and gaps therebetween is disclosed. However, international publication No. 2005/121767 does not disclose the flow of the sample solution which moves along the longitudinal direction of the channel is disturbed and does not point out the necessity, either.

In addition, the point that blocking materials each of which has a columnar structure being disposed at the branch point of the channel and the flow of fine particles being operated is disclosed in JP-A-2004-354364. However, JP-A-2004-354364 does not disclose the point that the flow of the sample solution which moves in a straight line along the longitudinal direction of the channel is disturbed and does not point out the necessity, either.

### SUMMARY

The invention has been made in view of the above situation, and it is an object of the invention to provide an electrophoresis chip capable of suppressing the drift phenomenon.

In order to achieve the above object, according to an aspect of the invention, an electrophoresis chip includes: a channel which separates a sample by isoelectric focusing electrophoresis; and a plurality of columnar structures disposed all over the channel. The columnar structures are disposed such that the flow of a sample solution, which moves in the longitudinal direction of the channel, is disturbed.

Furthermore, according to another aspect of the invention, an electrophoresis chip includes: a channel which separates a sample by isoelectric focusing electrophoresis; and a plurality of columnar structures disposed all over the channel. Arrays of the columnar structures disposed in a predetermined region within the channel are regularly disposed all over the channel. The columnar structures include a first columnar structure whose position in the channel is expressed as (x1, y1), a second columnar structure whose position in the channel is expressed as (x2, y2), and a third columnar structure whose position in the channel is expressed as (x3, y3) assuming that the longitudinal direction of the channel is an x-axis direction and the width direction of the channel perpendicular to the longitudinal direction of the channel is a y-axis direction. The first to third columnar structures are disposed adjacent to each other. The first and third columnar structures are disposed before the second columnar structure in the x-axis direction such that x1<x2 and x3<x2 are satisfied. The second columnar structure is disposed between the first and third columnar structures in the y-axis direction such that y1<y2<y3 is satisfied.

As a result, it becomes possible to suppress the drift phenomenon.

### BRIEF DESCRIPTION OF THE DRAWINGS

FIGS. 1A and 1B are plan and cross-sectional views illustrating the schematic configuration of an electrophoresis chip in the present embodiment;

FIG. 2 is a view for explaining the outline of the electrophoresis chip of the present embodiment;

FIG. 3 is a view illustrating the columnar structure arrangement formed in a channel, which shows an example of the arrangement in which it is difficult to disturb the flow in the longitudinal direction of the channel;

FIG. 4 is a view illustrating the columnar structure arrangement formed in a charmer, which shows an example of the arrangement in which the flow in the longitudinal direction of the channel is disturbed;

FIG. 5 is a view illustrating a temporal change of the fluorescence profile obtained in the columnar structure arrangement shown in FIG. 3;

FIG. 6 is a view illustrating a temporal change of the fluorescence profile obtained in the columnar structure arrangement shown in FIG. 4;

FIG. 7 is a plan view illustrating the columnar structure arrangement in which the columnar structures are disposed such that Y shaped grooves are formed;

FIG. 8 is a plan view illustrating the columnar structure arrangement in which the columnar structures are disposed such that T shaped grooves are formed;

FIG. 9 is another plan view illustrating the columnar structure arrangement in which the columnar structures are disposed such that T shaped grooves are formed;

FIG. 10 is another plan view illustrating the columnar structure arrangement in which the columnar structures are disposed such that Y shaped grooves are formed;

FIG. 11 is a view illustrating the case where arrays of the columnar structures disposed in a region within a predetermined channel are regularly disposed all over the channel; and

FIG. 12 is a view illustrating another case where arrays of the columnar structures disposed in a region within a predetermined channel are regularly disposed all over the channel.

### DETAILED DESCRIPTION OF PREFERRED EMBODIMENTS

### <Outline of an Electrophoresis Chip>

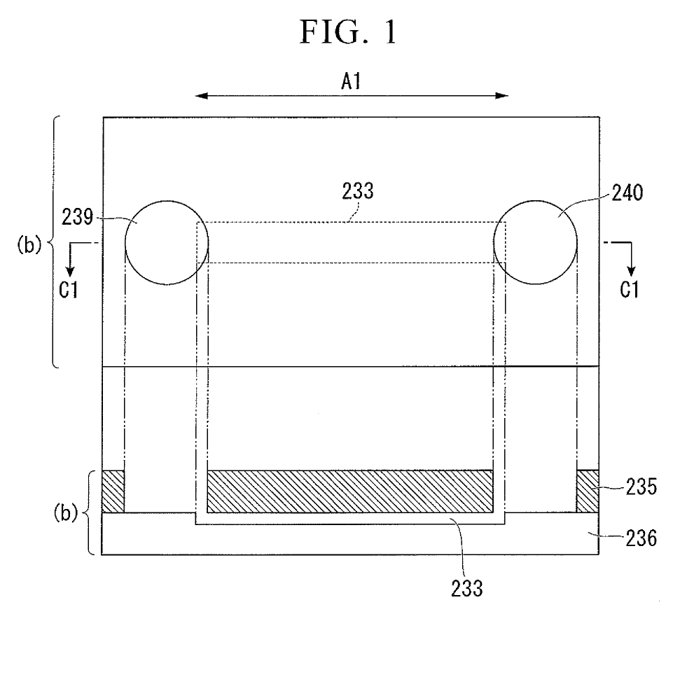

First the outline of all electrophoresis chip of the present embodiment will be described with reference to FIGS. 1A, 1B, and 2.

The electrophoresis chip of the present embodiment has a channel 233 for separating a sample by isoelectric focusing electrophoresis, as shown in FIGS. 1A and 1B. The electrophoresis chip of the present embodiment has a plurality of columnar structures disposed all over the channel 233. As shown in FIG. 2, the columnar structures are disposed such that the flow of the sample solution, which moves in a straight line along the longitudinal direction of the channel 233, is disturbed. In FIG. 2, the length D1 is 50 μm.

As shown in FIG. 2, the longitudinal direction A1 of the channel is set as the x-axis direction, and the width direction B1 of the channel perpendicular to the longitudinal direction A1 of the channel is set as the y-axis direction. The electrophoresis chip has a first columnar structure 101 whose position in the channel is expressed as (x1, y1), a second columnar structure 102 whose position in the channel is expressed as (x2, y2), and a third columnar structure 103 whose position in he channel is expressed as (x3, y3). The first to third columnar structures 101, 102, and 103 are disposed adjacent to each other. In addition, the first and third columnar structures 101 and 103 are disposed before the second columnar structure 102 in the x-axis direction. That is, x1<x2 and x3<x2. In addition, the second columnar structure 102 is disposed between the first and third columnar structures 101 and 103 in the y-axis direction. That is, y1<y2<y3. Thus, in the electrophoresis chip of the present embodiment, the columnar structures are disposed such that the flow of the sample solution, which moves in a straight line along the longitudinal direction A1 of the channel, is disturbed. As a result, it becomes possible to suppress the drift phenomenon.

Moreover, in the electrophoresis chip of the present embodiment, arrays of the columnar structures shown in the FIG. 2 which are disposed in a region within a predetermined channel are regularly disposed all over the channel 233 shown in FIGS. 1A and 1B. Accordingly, since the drift generated in the entire channel 233 can be made to be uniform, it becomes possible to suppress the drift phenomenon. Hereinafter, the electrophoresis chip of the present embodiment will be described in detail with reference to the accompanying drawings.

First, the configuration of the electrophoresis chip of the present embodiment will be described with reference to FIGS. 1A and 1B. FIG 1A is a plan view illustrating the schematic configuration of the electrophoresis chip in the present embodiment. FIG. 1B is a cross-sectional view taken along the line C1-C1 of FIG. 1A.

The electrophoresis chip in the present embodiment has a substrate 236 and a lid 235. The channel 233 is formed in the substrate 236. Liquid reservoirs 239 and 240 are formed at both ends of the channel 233. The channel 233 communicates with the liquid reservoirs 239 and 240. In addition, the liquid reservoirs 239 and 240 have electrodes (not shown) formed by insertion of the platinum line (not shown).

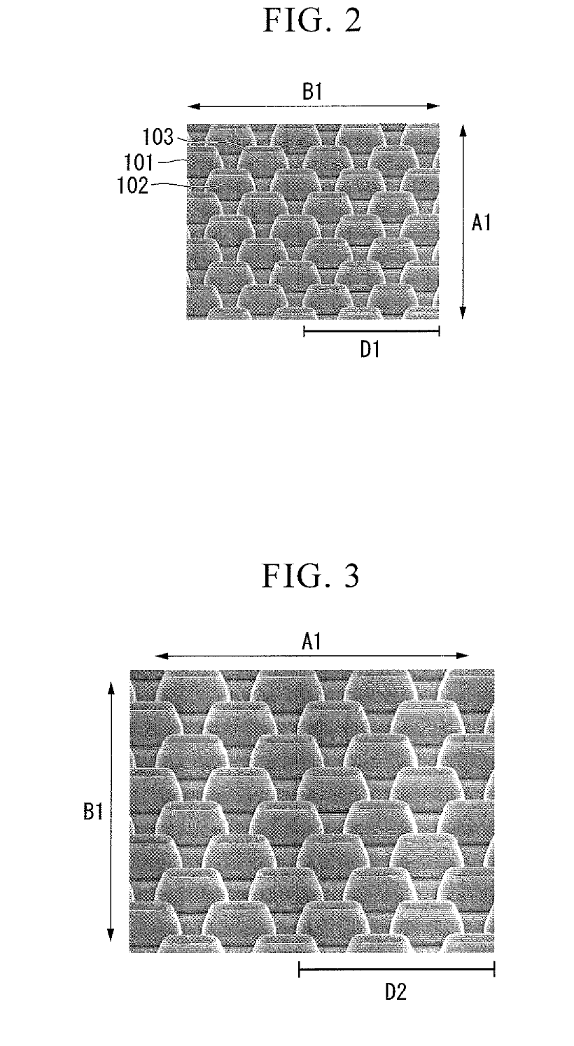

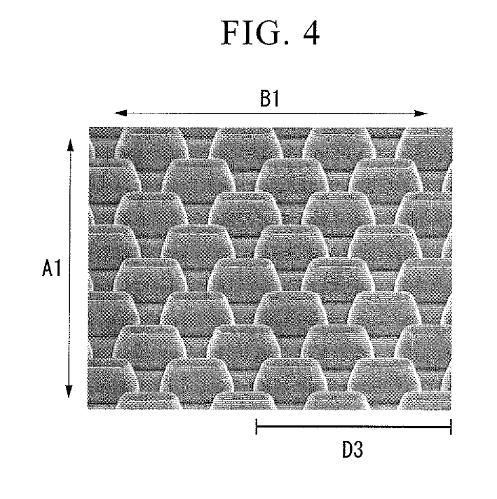

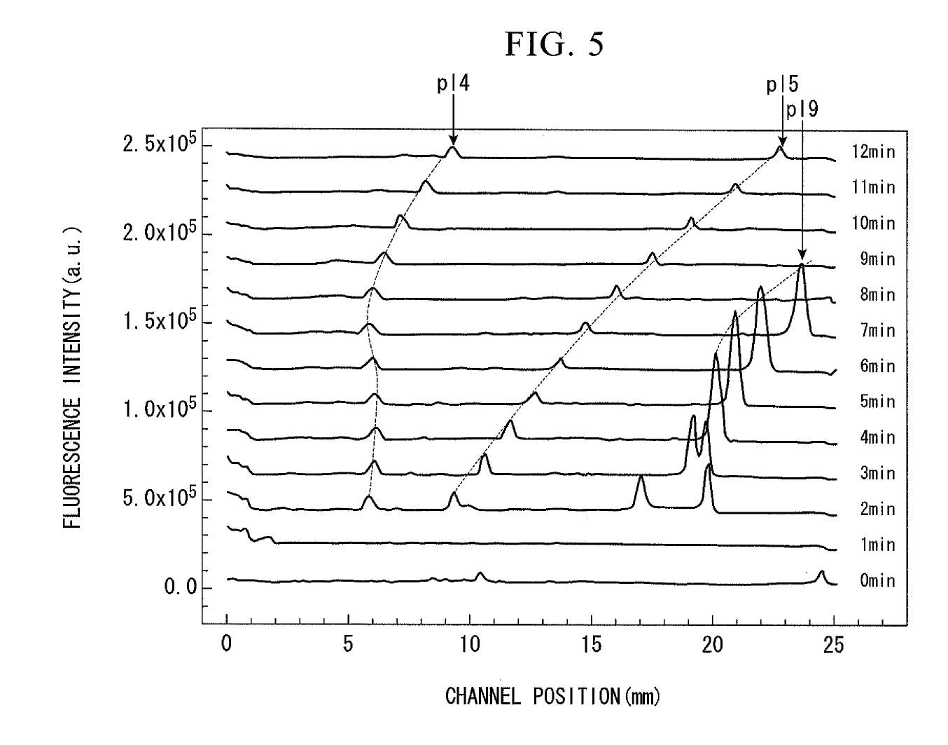

FIGS. 3 and 4 are photographs obtained by photographing the arrangement of the columnar structures formed in the channel 233 with the scanning electron microscope. FIG. 3 shows the case where columnar structure arrays are disposed in the longitudinal direction A1 of the channel. In FIG. 3, the length D2 is 50 μm. FIG. 4 shows the case where columnar structure arrays are disposed in the width direction B1 of the channel. In FIG. 4, the length D3 is 50 μm. In addition, other elements, such as the shape of the columnar structure and the internal volume of a channel, excluding the direction of the columnar structure arrangement do not change at all. Moreover, as a method for slowing down the flow of the sample solution, a method of dropping a voltage may be considered. However, if the voltage is dropped, focus of protein gradually weakens and is not focused eventually. For this reason, in the present embodiment, the voltage is not dropped.

In the columnar structure arrangement shown in FIG, 3, grooves between the columnar structures are formed in a straight line in the longitudinal direction A1 of the channel. Accordingly, the grooves are disposed such that it is difficult to disturb the flow of the sample solution in the longitudinal direction A1 of the channel. Actually, the speed at which the sample solution moved to the inside of the channel was almost twice the speed in the case of the columnar structure arrangement shown in FIG. 4.

In the columnar structure arrangement shown in FIG. 4, grooves between the columnar structures are formed in a straight line in the width direction B1 of the channel. However, the columnar structures are disposed such that the view is completely obstructed in the longitudinal direction A1 of the channel. That is, they are disposed so as to disturb the flow of the sample solution in the longitudinal direction of the channel. Actually, the speed at which the sample solution moved to the inside of the channel was almost half the speed in the case of the columnar structure arrangement shown in FIG. 3.

In cases of the columnar structure arrangements shown in FIGS. 3 and 4, isoelectric focusing electrophoresis was performed by using the same sample solution under the same conditions. In order to check the progress situation of the isoelectric focusing electrophoresis, fluorescent markers with the isoelectric points of 4, 5, and 9 were mixed in the sample solution and the fluorescence profile of the channel was observed as time elapsed.

FIG. 5 is a graph illustrating the temporal change of the fluorescence profile obtained in the case of the columnar structure arrangement shown in FIG. 3. In FIG. 5, the horizontal axis indicates the channel position (mm), and the vertical axis indicates the fluorescence intensity (a.u.). In FIG. 5, in order of early focus, the fluorescence profile of the fluorescent marker of pI4, the fluorescent marker of pI5, and the fluorescent marker of pI9 is observed. According to the temporal change of the fluorescence profile, it takes 4 minutes (4 min) until the fluorescent marker of pI9 with the latest focus becomes one peak and the focus ends. On the other hand, due to the drift, the peak of the fluorescent marker of pI9 is observed even after 7 minutes (7 min) and disappears after 8 minutes (8 min).

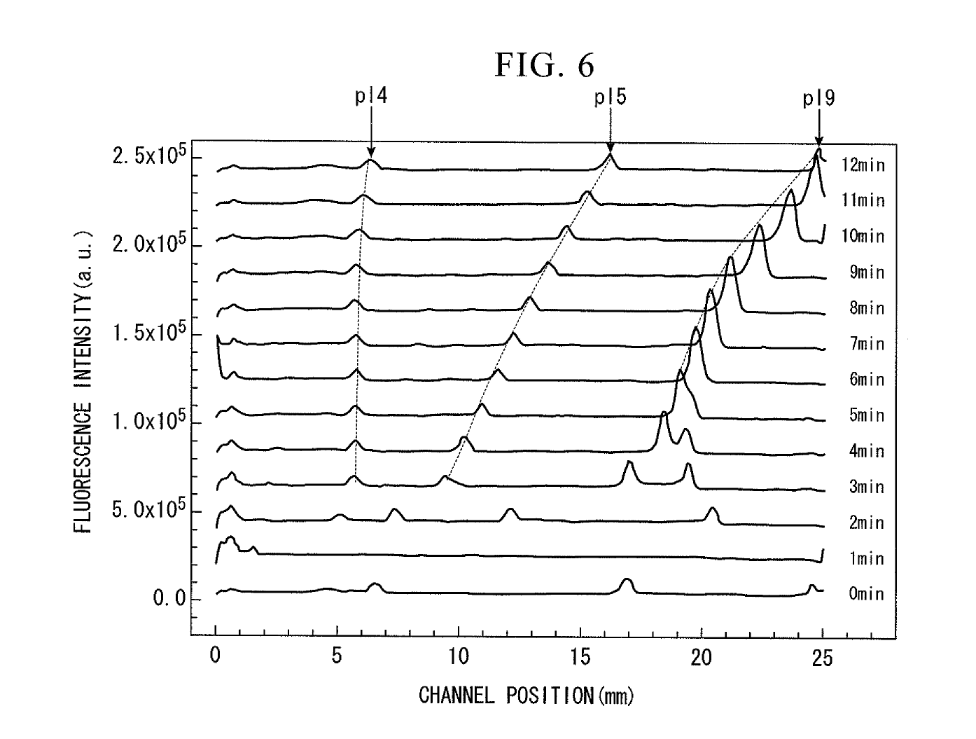

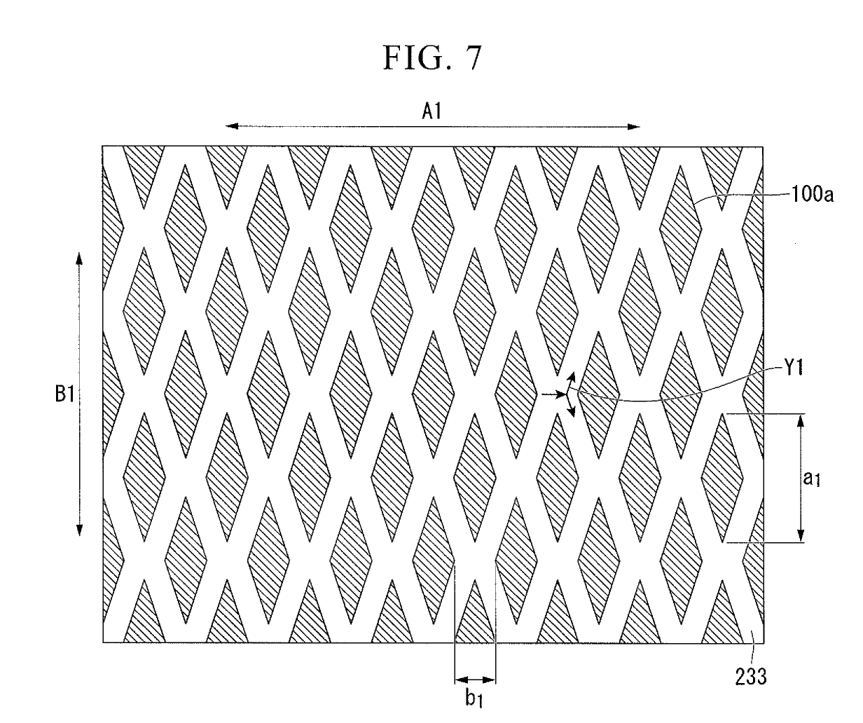

FIG. 6 is a graph illustrating the temporal change of the fluorescence profile obtained in the case of the columnar structure arrangement shown in FIG. 4. In FIG. 6, the horizontal axis indicates the channel position (mm), and the vertical axis indicates the fluorescence intensity (a.u.). According to the temporal change of the fluorescence profile, it takes 6 minutes (6 min) until the focus of the fluorescent marker of pI9 with the latest focus ends. On the other hand, due to the drift, the peak of the fluorescent marker of pI9 is observed even after 11 minutes (11 min) and disappears after 12 minutes (12 min).

Thus, in the case of the columnar structure arrangement shown in the FIG. 3 that is the arrangement where it is difficult to disturb the flow of the sample solution in the longitudinal direction A1 of the channel, the peak of pI9 can be observed for only 3 minutes. On the other hand, in the case of the columnar structure arrangement shown in the FIG. 4 that is the arrangement where it is possible to disturb the flow of the sample solution in the longitudinal direction A1 of the channel, the peak of pI9 can be observed for 5 minutes. Accordingly, when the time of isoelectric focusing electrophoresis is decided as 6 minutes, the drift error which changes according to the end time error or the error resulting from various samples or electrophoresis conditions is also decreased. For this reason, in the case of the columnar structure arrangement shown in FIG. 4, the probability (reproducibility) of reproducing the same observation result each time can be increased compared with the case of the columnar structure arrangement shown in FIG. 3.

In addition, the columnar structure arrangement in which it is difficult to disturb the flow of the sample solution in the longitudinal direction A1 of the channel means that the columnar structures are disposed such that the view is made worse in the longitudinal direction A1 of the channel or that the grooves on the root bypassing the columnar structures which disturb the flow are also formed narrow, for example. Here, ‘narrow’ means that the length of the groove between the columnar structures is 50 μm or less.

Moreover, in the present embodiment, the columnar structure arrangement shown in FIG, 4 which is easy to be compared with the columnar structure arrangement shown in FIG. 3 was described as an example. However, the columnar structure arrangement of the present embodiment is not limited to the columnar structure arrangement shown in FIG. 4, and the columnar structure arrangement in which it is difficult to disturb the more general flow may also be applied.

For example, the columnar structure arrangement shown in FIG. 7 may be applied. In FIG. 7, columnar structures 100n are disposed in the shape of a checkerboard. That is, the columnar structures 100a are disposed at first distances in the longitudinal direction A1 of the channel and are also disposed at second distances in the width direction B1 of the channel. In addition, the largest width of the columnar structure 100a in the width direction B1 of the channel is a₁. The columnar structures 100a are disposed at equal distances in the longitudinal direction A1 of the channel. The length of the groove between the columnar structures 100a in the longitudinal direction A1 of the channel is b₁. The columnar structures 100a are disposed at equal distances in the width direction B1 of the channel. In FIG. 7, the columnar structures 100a are disposed such that the width a₁ is larger than the length b₁. Specifically, the columnar structures 100a are disposed such that b₁=2a₁/5 is satisfied. In FIG. 7, the columnar structures 100a form a Y shaped groove Y1.

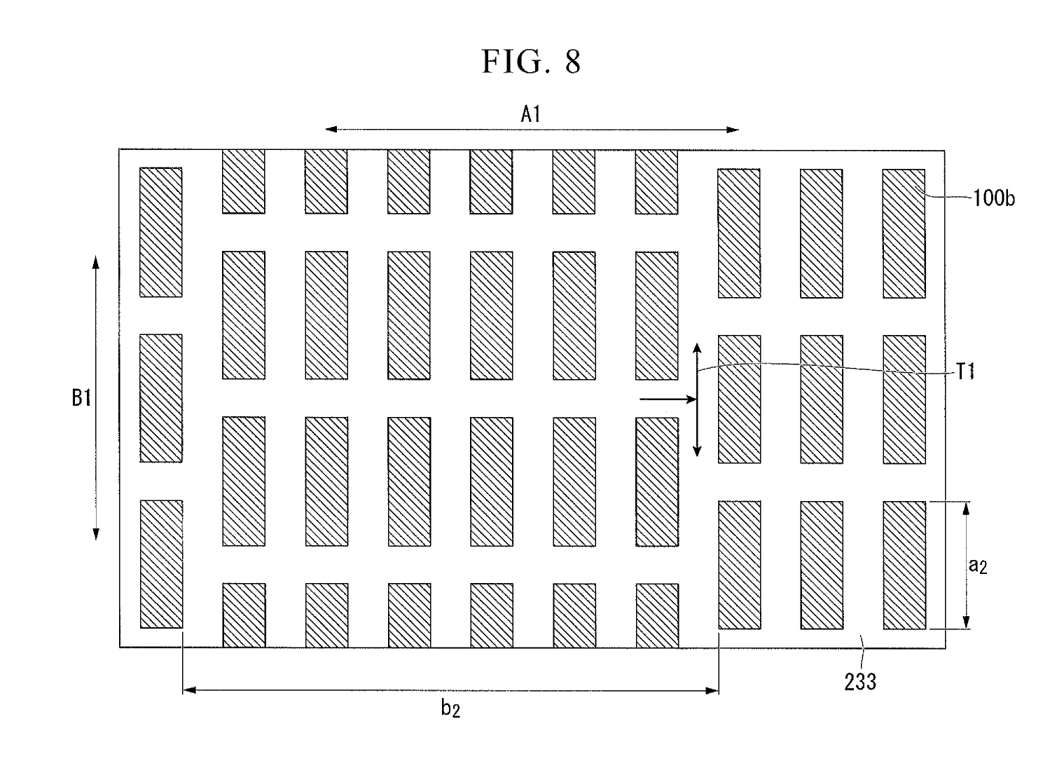

In addition, the columnar structure arrangements shown in FIGS. 8 to 10 may be applied. FIGS. 8 to 10 show the columnar structure arrangements in which the length (b₂, b₃, b₄) between the columnar structures (100b, 100c, 100d) disposed in the longitudinal direction A1 of the channel is within the range of 5 times the width (a₂, a₃, a₄) of the columnar structure in the width direction B1 of the channel, and the columnar structures (100b, 100c, 100d) are disposed such that a T or Y shaped groove (T1, T2, Y1) is formed within the range of 5 times.

In FIG. 8, when the largest width of the columnar structure 100b in the width direction B1 of the channel is set to a₂, the length b₂ of the groove between the columnar structures 100b disposed in the longitudinal direction A1 of the channel is b₂=13a₂/3. In addition, the columnar structures 100b are disposed such that the T shaped groove T1 is formed within the range of the length b₂ of the groove between the columnar structures 100b.

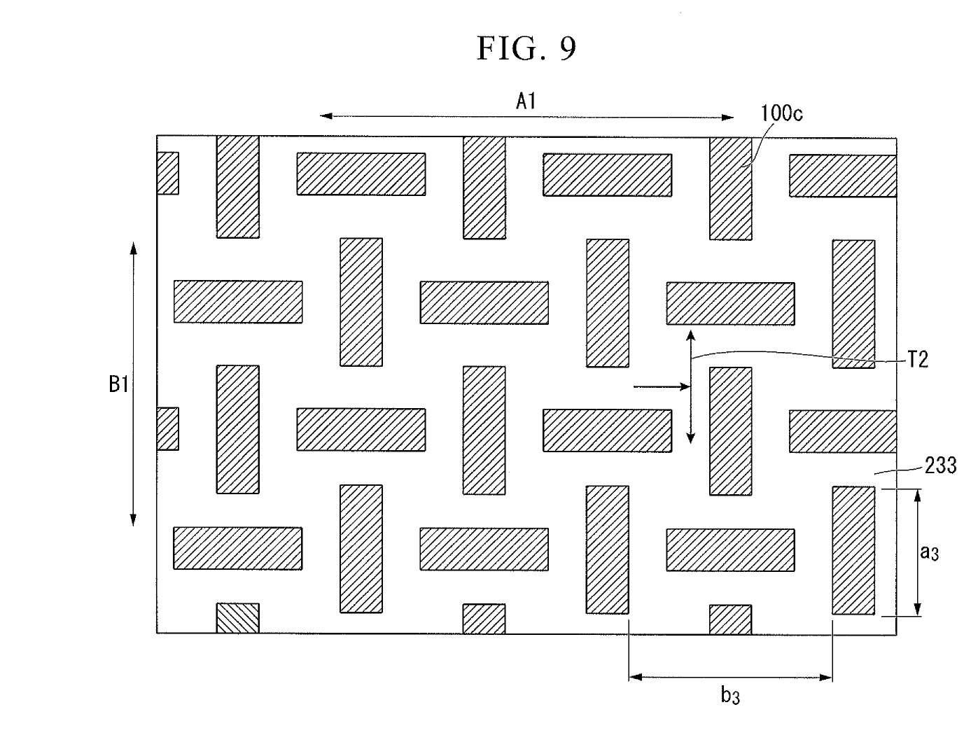

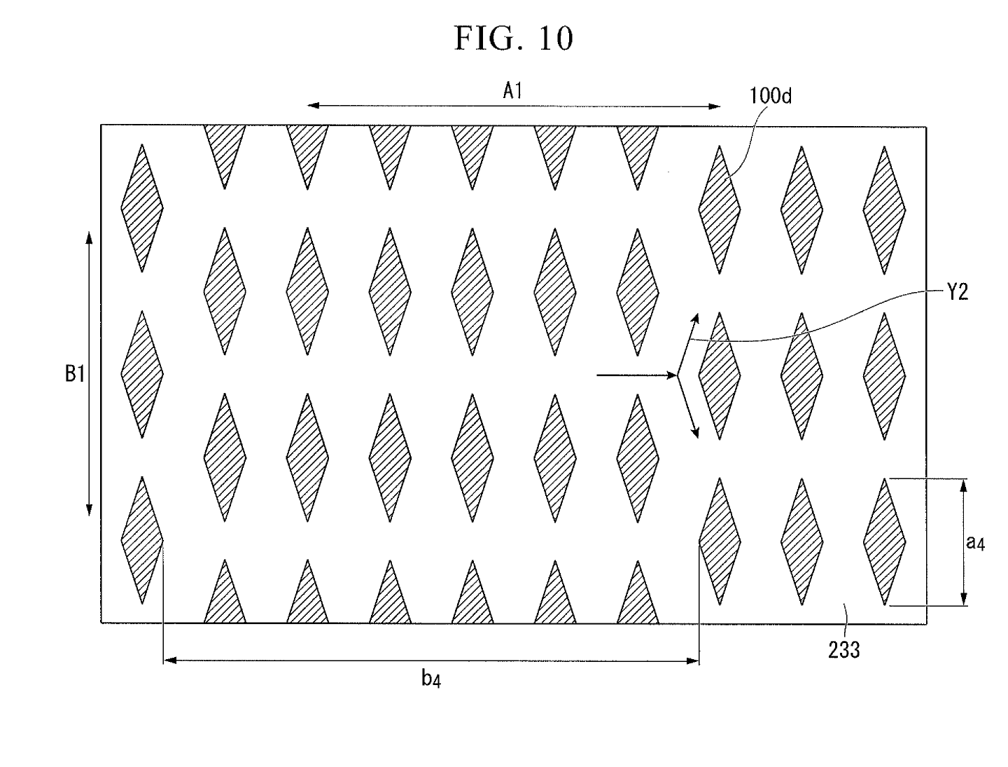

Moreover, in FIG. 9, when the largest width of the columnar structure 100c in the width direction B1 of the channel is set to a₃, the length b₃ of the groove between the columnar structures 100c disposed in the longitudinal direction A1 of the channel is b₃=10a₃/6. In addition, the columnar structures 100c are disposed such that the T shaped groove T2 is formed within the range of the length b₃ of the groove between the columnar structures 100c.

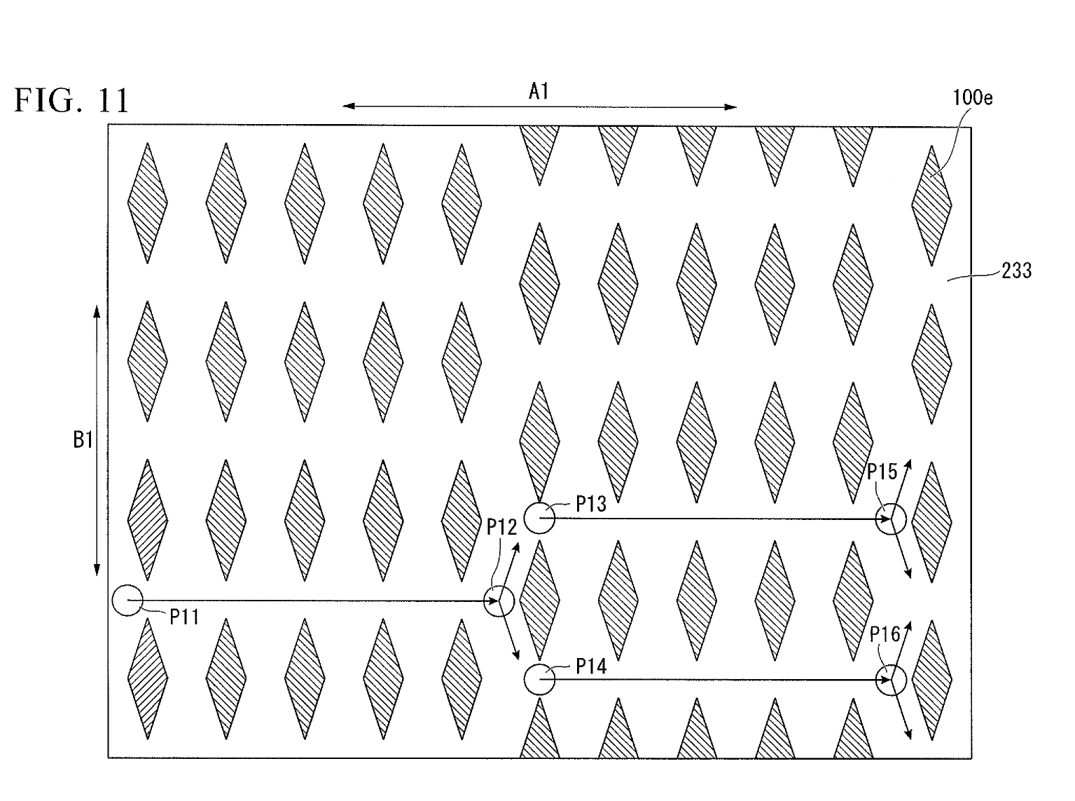

Moreover, in FIG. 10, when the largest width of the columnar structure 100d in the width direction B1 of the channel is set to as, the length b₄ of the groove between the columnar structures 100d disposed in the longitudinal direction A1 of the channel is b₄=13a₄/3. In addition, the columnar structures 100d are disposed such that the Y shaped groove Y2 is formed within the range of the length b₄ of the groove between the columnar structures 100d.

In the columnar structure arrangement of the present embodiment, when the columnar structures 100a are not disposed in the shape of a checkerboard unlike FIG. 7, the T or Y shaped groove is formed such that the length of the groove between the columnar structures disposed in the longitudinal direction A1 of the channel is within the range of 5 times the width of the columnar structure in the width direction B1 of the channel as show in FIGS. 8 to 10.

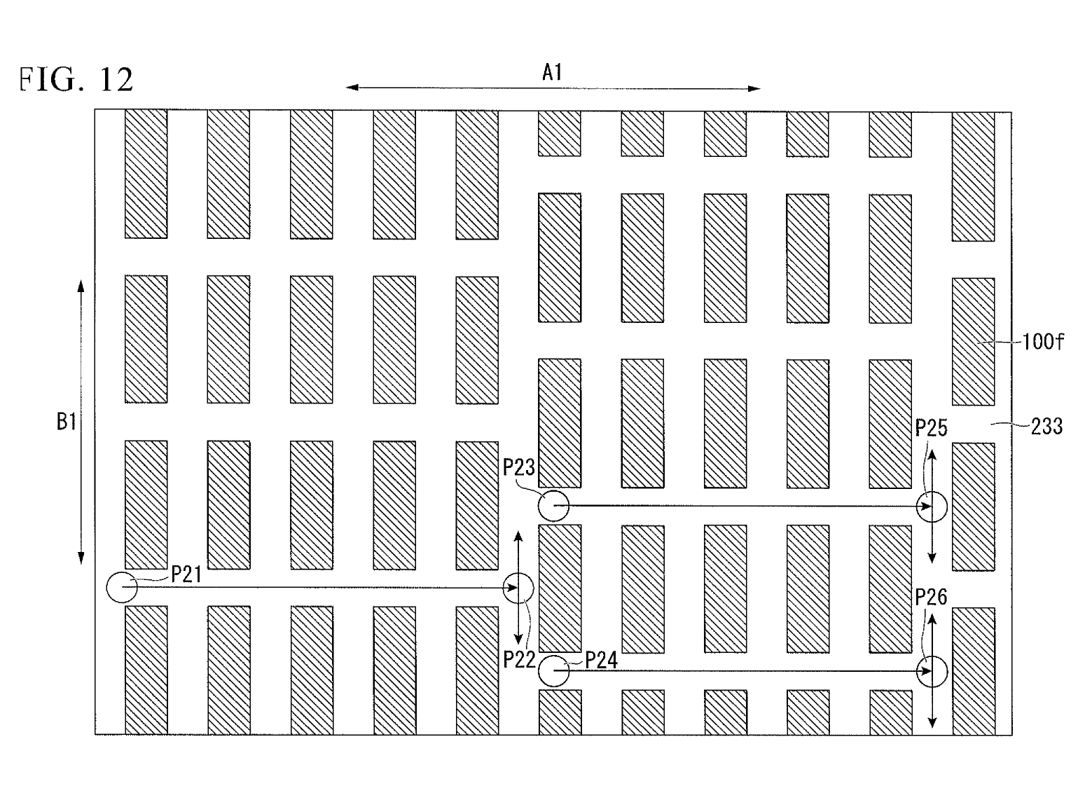

In addition, when the columnar structure arrays are disposed within the channel 233, it is preferable that the columnar structure arrays disposed in a region within the predetermined channel 233 be regularly disposed all over the channel 233 as shown in FIGS. 11 and 12.

In FIG. 11, the columnar structures 100e with the rhombic cross sections are regularly disposed in the channel 233. In he case of the columnar structure arrangement shown in FIG. 11, the flow of the solution in the longitudinal direction A1 of the channel in a portion of an end point p12 shown in FIG. 11 becomes faster than that at a starting point p11. In addition, the solution branches up and down in the portion of the end point p12. In portions of starting points p13 and p14, the flow of the solution in the longitudinal direction A1 of the channel again becomes slower than that at the end point p12. In portions of starting points p15 and p16, the flow of the solution in the longitudinal direction A1 of the channel becomes faster than that at the starting points p13 and p14.

In FIG. 12, the columnar structures 100f with the rectangular cross sections are regularly disposed in the channel 233. In the case of the columnar structure arrangement shown in FIG. 12, the flow of the solution in the longitudinal direction A1 of the channel in a portion of art end point p22 shown in FIG. 12 becomes faster than that at a starting point p21. In addition, the solution branches up and down in the portion of the end point p22. In portions of starting points p23 and p24, the flow of the solution in the longitudinal direction A1 of the channel again becomes slower than that at the end point p22. In portions of starting points p25 and p26, the flow of the solution in the longitudinal direction A1 of the channel becomes faster than that at the starting points p23 and p24.

For this reason, in the cases of the columnar structure arrangements shown in FIGS. 11 and 12, the drift changes when viewed locally (when viewed only in a region within a predetermined channel). However, by regularly disposing the columnar structure arrays, which are disposed in the region within the predetermined channel 233, all over the channel 233, the change of drift can be weakened when viewed on the whole (when viewed in the entire channel 233). Therefore, it becomes possible to suppress the drift phenomenon by regularly disposing the columnar structure arrays, which are disposed in the region within the predetermined channel 233, all over the channel 233. In addition, the columnar structures can be easily formed in the channel 233 by regularly disposing the columnar structure arrays all over the channel 233. As a result, an electrophoresis chip can be manufactured easily.

The surface which is in contact with the sample solution within the channel 233 is preferably lyophilic for the sample solution. In this case, it becomes possible to realize the columnar structure arrangement in which it is difficult to disturb the flow of the sample solution in the longitudinal direction A1 of the channel while making the solution easily introduced into the channel 233.

The surface which is in contact with the sample solution within the channel 233 is more preferably super-lyophilic for the sample solution. In this case, it becomes possible to realize the columnar structure arrangement in which it is difficult to disturb the flow of the sample solution in the longitudinal direction A1 of the channel while making the solution more easily introduced into the channel 233.

For example, quartz glass is used as a material of the substrate 236. Since the surface of the substrate 236 has lyophilicity by the quartz glass, the channel 233 can be appropriately formed. In addition, glass, such as Pyrex (registered trademark), a plastic material, or the like may be used as materials of the substrate 236. Examples of the plastic material include thermoplastic resins, such as a silicon rest, PMMA (polymethyl methacrylate), PET (polyethylene terephthalate), and PC (polycarbonate), and thermosetting resins, such as an epoxy resin. Since such materials are easy molded, manufacturing cost can be suppressed. In addition, it is also possible to use metal for the substrate 236.

Moreover, the columnar structures formed in the channel 233 may be formed, for example, by etching the substrate 236 in a predetermined pattern shape. In addition, the manufacturing method when forming the columnar structures in the channel 233 is not particularly limited, and any method may be applied.

Moreover, the shape of the columnar structure of the present embodiment is riot particularly limited. For example, the shape of the columnar structure is not limited to the pseudo-cylindrical shape, such as a cylinder and an elliptical cylinder, and cones such as a circular cone and an elliptical cone, polygonal columns such as a triangular prism and a quadrangular prism, and columns having other cross-sectional shapes may also be applied. In this case, in order to accurately control the flow of fine particles, the column is more preferable than the cone.

Moreover, as for the size of the columnar structure of the present embodiment, it is preferable that the width of the columnar structure be about 10 nm to 10 μm, for example. In addition, it is preferable that the width of the groove between the columnar structures be appropriately selected according to the shape and size of the fine particle flowing into the channel 233. In addition, the width of the groove between the columnar structures is preferably 10 or more times the molecular size of a component included in a sample solution. For example, the size of peptide or protein separated by isoelectric focusing electrophoresis is about 20 nm in general even if it is large. In this case, it is preferable that the width of the groove between the columnar structures be at least 200 nm, or more. Thus, it becomes possible to suppress the flow of the sample solution without the sample solution being disturbed. In addition, the width of the groove between the columnar structures means the width of the groove in the width direction B1 of the channel, and the length of the groove between the columnar structures means the length of the groove in the longitudinal direction A1 of the channel.

Moreover, it is preferable that the upper surface of each columnar structure be built to match the upper surface of the channel within ±3 nm. This makes it possible to keep the sample solution from easily flowing between the lid 235 of the upper surface of the channel 233 and the upper surface of the columnar structure.

Next, a method of manufacturing the electrophoresis chip of the present embodiment will be described. In addition, the channel 233 and the columnar structures can be formed on the substrate 236, for example, by etching the substrate 236 in the predetermined pattern shape. However, the manufacturing method is not particularly limited, and any method may be applied.

For example, they may be manufactured by using photolithography using a thick-film resist for microfabrication. The thick-film resist is used as a negative resist for photolithography and may be appropriately used as a resist for microfabrication of a micrometer scale.

First, a water repellent layer (not shown) and a thick resist layer are sequentially formed on the substrate 236. The thickness of the water repellent layer is 400 nm, and the thickness of the thick resist layer is 10 μm. Then, a pattern on the chip, such as a columnar structure pattern, is exposed using the exposure device. Development is performed using a developer. By this process, the thick-film resist is patterned.

Then, the water repellent layer and the glass substrate are removed by dry etching using a resist mask and the mixed gas of CF₄ and CHF₃. The remaining photoresist is removed by peeling liquid, and then the resist which still remains is Removed by plasma oxidation treatment. As a result, the channel 233 and columnar structures are formed on the substrate 236.

Here, coating treatment for promoting the lyophilicity of the surface of the substrate 236 is performed By making the surface of the substrate 236 lyophilic, the sample solution is smoothly introduced into the channel 233 or the columnar structures. Particularly by the columnar structures, introduction of the sample solution based on the capillary phenomenon of is promoted. As a result, the flow operation precision can be improved.

Then, for example, the region where the glass surface of the surface of the substrate 236 is exposed, that is, an inner wall and a bottom surface of the etched channel 233 and side walls of the, columnar structures are coated with a linear polyacrylamide film after the etching process. That is, the linear polyacrylamide film is formed by performing the silane coupling process and then polymerizing the linear polyacrylamide while making the linear polyacrylamide react with the silane coupling agent on the surface. The linear polyacrylamide film is effective in maintaining the hydrophilic property for a long time and suppressing adsorption of protein or the like. In addition, the surface of the substrate 236 which is not etched, such as the outside of the channel 233, shows the water repellent property because the water repellent layer remains on the surface. Accordingly, the liquid is difficult to leak to the outside of the channel 233. Finally, the silicon rubber lid 235 with the self-adhesive property is bonded to the substrate 236 while being aligned with the substrate 236. Thus, the electrophoresis chip is completed.

Moreover, when a plastic material is used for the substrate 236, the known methods suitable for the type of the material of the substrate 236, which include etching or press molding using a die, such as embossing molding, injection molding, and photo-curable formation, is applied.

Also when the plastic material is used for the substrate 236, it is preferable to make the surface of the substrate 236 lyophilic. By making the surface of the substrate 236 lyophilic, the sample solution is smoothly introduced into the channel 233 or the region where the columnar structures are formed.

As surface treatment for lyophilicity, for example, a process of covalently binding a linear polyacrylamide film or a polyethylene glycol film on the surface by silane coupling is performed.

In addition, the electrophoresis chip of the present embodiment may be easily manufactured by applying the microfabrication technology used for manufacture of MEMS (Micro Electro Mechanical Systems) or semiconductor devices. In addition, press machining, sandblasting, or the like may also be applied.

In addition, in the isoelectric focusing electrophoresis, the channel 233 communicates with the liquid reservoirs 239 and 240. Preferably, the columnar structures of the present embodiment are provided on the entire bottom surfaces of the liquid reservoirs 239 and 240 or parts of the bottom surfaces adjacent to the channel 233 and in the entire region from a channel portion adjacent to one liquid reservoir 239 to a channel portion adjacent to the other liquid reservoir 240. This is because the isoelectric focusing electrophoresis and the drift phenomenon occur in the liquid reservoirs 239 and 240 and the channel 233 which communicates therewith. Therefore, it is preferable that the columnar structures of the present embodiment be disposed all over the channel 233.

### <Operation and Effect of the Electrophoresis Chip of the Present Embodiment>

Thus, according to the present embodiment, the plurality of columnar structures disposed in the channel 233 is disposed such that the flow of the sample solution, which moves in a straight line along the longitudinal direction of the channel 233, is disturbed as shown in FIG. 4. This makes it possible to reduce the speed of the drift phenomenon which disturbs the reproducibility, compared with the speed of the isoelectric focusing electrophoresis. As a result it becomes possible to suppress the drift phenomenon.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An electrophoresis chip comprising:
a channel which separates a sample by isoelectric focusing electrophoresis; and
a plurality of columnar structures disposed all over the channel,
wherein the columnar structures are disposed such that the flow of a sample solution, which moves m the longitudinal direction of the channel, is disturbed.

2. The electrophoresis chip according to claim 1,
wherein a surface which is in contact with a sample solution flowing through the channel is lyophilic to the sample solution.

3. The electrophoresis chip according to claim 1,
wherein a surface which is in contact with a sample solution flowing through the channel is super-lyophilic to the sample solution.

4. The electrophoresis chip according to claim 1,
wherein the length of a groove between the columnar structures which forms a straight line along the longitudinal direction of the channel is 50 μm or less.

5. The electrophoresis chip according to claim 1,
wherein the width of the columnar structure in the width direction of the channel perpendicular to the longitudinal direction of the channel is larger to the length of the groove between the columnar structures disposed in the longitudinal direction of the channel.

6. The electrophoresis chip according to claim 1,
wherein the length of the groove between the columnar structures disposed in the longitudinal direction of the channel is within the range of 5 times the width of the columnar structure in the width direction of the channel perpendicular to the longitudinal direction of the channel, and the columnar structures are disposed such that a T or Y shaped groove is formed within the range of the 5 times.

7. The electrophoresis chip according to claim 1,
wherein the width of the groove between the columnar structures is 10 or more times the molecular size of a component included in the sample solution.

8. An electrophoresis chip comprising;
a channel which separates a sample by isoelectric focusing electrophoresis; and
a plurality of columnar structures disposed all over the channel,
wherein arrays of the columnar structures disposed in a predetermined region within the channel are regularly disposed all over the channel,
the columnar structures include a first columnar structure whose position in the channel is expressed as (x1, y1), a second columnar structure whose position in the channel is expressed as (x2, y2), and a third columnar structure whose position in the channel is expressed as (x3, y3) assuming that the longitudinal direction of the channel is an x-axis direction and the width direction of the channel perpendicular to the longitudinal direction of the channel is a y-axis direction,
the first to third columnar structures are disposed adjacent to each other, the first and third columnar structures are disposed before the second columnar structure in the x-axis direction such that x1<x2 and x3<x2 are satisfied, and
the second columnar structure is disposed between the first and third columnar structures in the y-axis direction such that y1<y2<y3 is satisfied.

9. The electrophoresis chip according to claim 8,
wherein a surface which is in contact with a sample solution flowing through the channel is lyophilic to the sample solution.

10. The electrophoresis chip according to claim 8,
wherein a surface which is in contact with a sample solution flowing through the channel is super-lyophilic to the sample solution.

11. The electrophoresis chip according to claim 8,
wherein the length of a groove between the columnar structures which forms a straight line along the longitudinal direction of the channel is 50 μm or less.

12. The electrophoresis chip according to claim 8,
wherein the width of the columnar structure in the width direction of the channel perpendicular to the longitudinal direction of the channel is larger than the length of the groove between the columnar structures disposed in the longitudinal direction of the channel.

13. The electrophoresis chip according to claim 8,
wherein the length of the groove between the columnar structures disposed in the longitudinal direction of the channel is within the range of 5 times the width of the columnar structure in the width direction of the channel perpendicular to the longitudinal direction of the channel, and the columnar structures are disposed such that a T or Y shaped groove is formed within the range of the 5 times.

14. The electrophoresis chip according to claim 8,
wherein the width of the groove between the columnar structures is 10 or more times thee molecular size of a component included in the sample solution.
